(19) United States
(12) Patent Application Publication
(10) Pub. No.: US 2008/0241811 A1
(43) Pub. Date: Oct. 2, 2008

(54) Birthday interview method and kit

(76) Inventor: Susan L. Fieldstein, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 12/070,842

(22) Filed: Feb. 21, 2008

Related U.S. Application Data
(60) Provisional application No. 60/908,613, filed on Mar. 28, 2007.

(51) Int. Cl. G09B 7/00; B65D 69/00; B65D 85/57

(52) U.S. Cl. 434/362; 206/233; 206/307.1

(57) ABSTRACT

A method is described for preserving memories of a child's growth by making annual videos of interviews with the child and permanently storing the videos. The interview is preferably conducted on or near the child's birthday using a list of questions directed to the same subject matter, thereby recording the evolution of the child's views and attitudes over time. Preferably, the interviews are conducted and recorded using a kit that includes a storage container, such as a covered box with indicia indicative of its purpose, a booklet of questions, a list of tips or suggestions, labels, and a sample of an interview.

This application claims the benefit of the filing date of U.S. Provisional Application Ser. No. 60/908,613, filed Mar. 28, 2007.

### BACKGROUND OF THE INVENTION

(1) Field of the Invention

The present invention relates to a method and kit for preserving memories of a childhood, and in particular to a method and kit for recording audio and video of annual interviews with the child on or near each of the child's birthdays.

(2) Description of the Prior Art

Parents' recordation of the growth of their child and the preservation of memories of the child's development is normally a haphazard undertaking, usually consisting primarily of photographs and home videos taken at random times, especially during the child's early years. Usually, the recordings are of the child engaged in some activity, such as opening presents, playing a sport, etc. Input from the child that preserves the child's views and mental attitudes at various ages is only coincidental to the recording of the events.

While all of these recordings are of considerable value and enjoyment to the parents, grandparents, and even the children after they become adults, there is still a need for a means for improving the recordation of a child's growth, particularly with the inclusion of the child's views at various ages. There is also a need for a means to facilitate the collection and preservation of these memories.

### SUMMARY OF THE INVENTION

Generally, one aspect of the present invention relates to a method of preserving memories of a childhood, and in particular to a method that preserves and compares a child's viewpoints at different ages. Another aspect of the invention relates to a kit that may be used to collect and preserve memories.

More specifically, the method of the invention comprises the steps of making video recordings of dialogs between an interviewer and a child at selected times at least annually, and preserving the videos together in a selected location. As used herein, the term “video recordings” is to be understood to encompass recordings that include a combination of a video recording along with a recording of the corresponding audio. The recording will normally be made using a camcorder or home video recorder, with the recording being stored on the camcorder recording medium, e.g., a CD, DVD or flash drive. It will be understood, however, that the present invention contemplates recording and storage by any other means that will result in permanent storage of the dialog.

Preferably, the format of the dialog is in the form of a series of questions asked by the interviewer, e.g., a parent or other person with whom the child is comfortable. Importantly, the subject matter of the series of questions should be consistent from interview to interview so that the evolution of a child's mental development and changes in maturity and attitude over time can be observed and recorded. For example, a list of questions directed to the same subjects can be used during each interview, with the presentation of the questions and the depth of the questioning reflecting the child's age and maturity. While the questions will be directed to the same subjects, the child's answers from year-to-year will change as the child matures.

Some possible questions include:

1. What is your name?

2. What is your address? What town do you live in?

3. How old are you today?

4. What did you do for your birthday?

5. Did you have a party? Who was there?

6. What presents did you get? Which was your favorite?

7. What was the weather like?

8. Where do you go to school?

9. What are your teachers' names? Do you like them?

10. Who are your friends in school?

11. What is your favorite sport to play? What is your favorite sport to watch?

12. Do you have a boy friend/girl friend?

13. Who do you think is cute in class? Who sits near you?

14. What is your favorite color?

15. Do you have a favorite song?

16. What is your favorite book?

17. Who is your favorite singing group/band?

20. What is your favorite TV program/movie?

21. If you had a whole day to do anything you wanted, what would you do?

22. What do you want to do when you grow up?

23. Do you think you will want to get married?

24. Do you want to have children? How many? Boys or girls?

25. If you had one wish, what would it be?

26. What kind of teenager do you think you will be?

27. How old do you think you will be when you date for the first time?

28. How late should you be able to stay out when you are a teenager?

29. What time should you have to go to bed when you are a teenager?

30. Do you think there should be consequences when you do something wrong? Other age appropriate questions can be included. If the child has a favorite song, encourage them to sing it. As the child grows older, more detailed questions can be asked. The question list is to ensure the repetition of consistent areas of discussion. However, the questions can be reworded to reflect the age of the child.

While the present invention contemplates conducting the interviews at other selected times, it is preferable to conduct the interviews on or near the child's birthday, since a primary purpose of the interview is to record and preserve the child's views and their evolution at different ages. Moreover, the event of the child's birthday aids as a reminder to conduct the interview.

Storage of the recorded interviews is equally important, since all of the effort and value will be lost if the memories are not stored in a place where they can be found when it is time for the next interview. For this purpose, the present invention also contemplates a storage container, preferably a decorative box that is sized to hold recorded CDs, DVDs, flash drive, or other recording media. Other relevant materials, such as a list of questions to ask during the interview, a list of tips for conducting interviews, video recordings of sample interviews, and recording media labels, can be included in the box.

Examples of tips to be listed include:

1. Let your child pick the spot for the interview.

2. Focus on toes, fingers, swinging legs, and facial expressions.

3. Use a separate recording medium for each child; label clearly.

4. Show enthusiasm about the interview.

5. Conduct the interview with as few people around as possible.

6. Keep the storage container in the same place.

7. Adjust the questions to the child's age.

8. Use the zoom feature sparingly.

9. Relax, smile, and keep in mind that this is a special time for you and your child.

The box can also be sized to store other momentos of the child's birthdays and birthday parties. Such items include, but are not limited to, invitations, print pictures, party favors, and other unique remembrances of the day.

The box can be made of any suitable material, such as cardboard or plastic. Preferably, as an aid to locating the container when it time for the next interview or when viewing of previously recorded interviews is desired, the box may have a distinctive shape or pattern that serves as a reminder of its purpose. Preferably, the box is in the shape of and/or includes indicia suggestive of a birthday cake. For example, the box can include an outwardly extending scalloped edge suggestive of a cake plate. Also, the box can be decorated with indicia such as printed icing or the image of a cake. Words such as “The Birthday Interview” can also be included to identify the container and its purpose. The box and recording media can also be packaged as a kit for sale to others.

### BRIEF DESCRIPTION OF THE DRAWINGS

FIG. 1 is a perspective view of a storage container.

FIG. 2 is a booklet of questions.

FIG. 3 is a list of tips.

FIG. 4 is a group of labels.

FIG. 5 is a sample DVD.

FIG. 6 is a plurality of DVDs recorded with annual interviews.

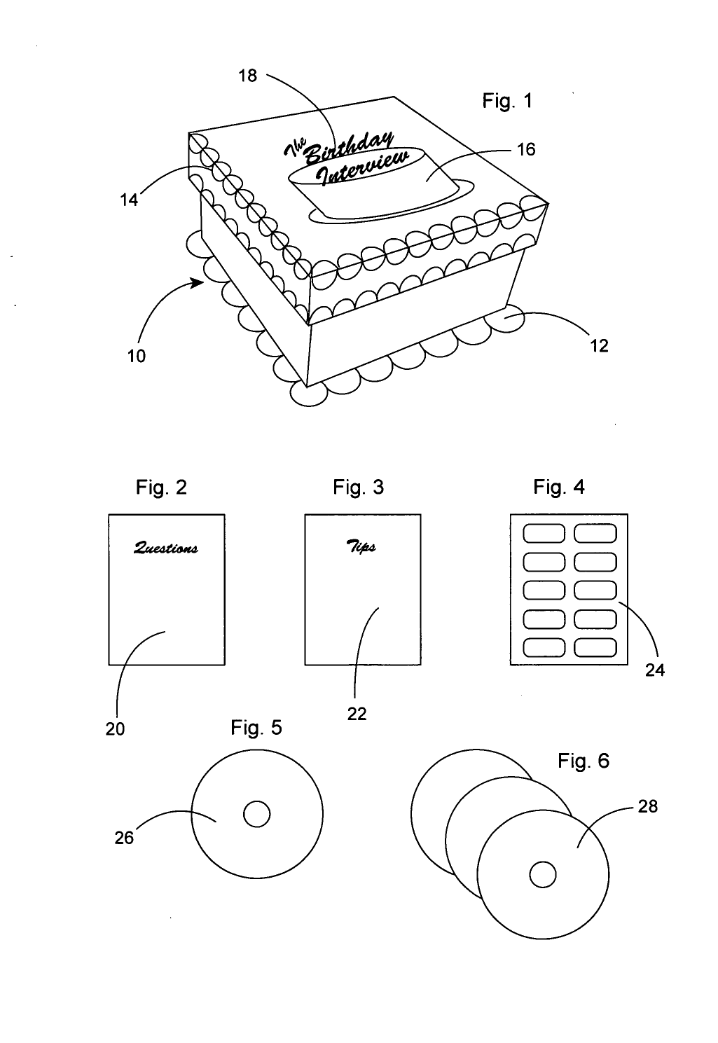

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

As illustrated in the drawings, the kit of the present invention is comprised of a covered storage container, generally 10, that may include one or more features that identify it as the repository of the materials relevant to the interviews. These features may include one or more of an outwardly extending base 12 simulating a cake plate, indicia simulating cake icing 14, an image of a birthday cake 16, and a suggestive name 18.

When the kit is packaged for sale, it may also include a booklet of questions 20, a list of tips 22, a plurality of labels 24, and a DVD 26 or other recorded media containing a sample interview. It will be understood that two or more of these items may be combined. For example, the booklet of questions and the list of tips can be printed together. After purchase and use, box 10 may also be used to store a plurality of DVDs 28 or other recorded media of prior interviews.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method of preserving memories of a child's growth comprising:
a) making video recordings of dialogs between an interviewer and a child at selected times at least annually; and
b) preserving the videos together in a selected location.

2. The method of claim 1, wherein the selected times are on or near the child's birthday.

3. The method of claim 1, wherein the selected location is a box sized to hold the video recordings.

4. The method of claim 1, wherein the dialog is comprised of a series of questions by the interviewer and answers by the child.

5. The method of claim 1, wherein the video recordings are stored on one or more CDs or DVDs.

6. A method of preserving memories of a child's growth comprising:
a) making video recordings of a series of questions by an interviewer and answers by the child on or near a plurality of the child's birthdays; and
b) preserving the videos together in a designated storage container.

7. The method of claim 6, wherein the same questions are asked in each recording.

8. The method of claim 6, wherein the storage container is a box having indicia simulating a birthday cake.

9. The method of claim 6, wherein the video recordings are made on one or more CDs or DVDs.

10. The method of claim 6, wherein the storage container includes a list of the questions.

11. A kit for preserving memories of a child's growth in the form of video recordings of a series of questions by an interviewer and answers by the child on or near a plurality of the child's birthdays comprising:
a) a storage container sized to hold recordings of interviews; and
b) a list of interview questions.

12. The kit of claim 11, wherein the storage container is a box with indicia simulating a birthday cake.

13. The kit of claim 11, further including a list of tips for conducting interviews.

14. The kit of claim 11, further including video recordings of sample interviews.

15. The kit of claim 11, further including recording media labels.
